(19) United States
(12) Patent Application Publication
(10) Pub. No.: US 2015/0037986 A1
(43) Pub. Date: Feb. 5, 2015

(54) CABLE CONNECTOR ASSEMBLY

(71) Applicant: HON HAI PRECISION INDUSTRY CO., LTD., New Taipei (TW)

(72) Inventors: JERRY WU, Irvine, CA (US); JUN CHEN, Kunshan (CN); FENG-JUN QI, Hefei (CN)

(21) Appl. No.: 14/447,521

(22) Filed: Jul. 30, 2014

(30) Foreign Application Priority Data
Jul. 30, 2013 (CN) 2013103234321

(51) Int. Cl. H01R 13/659; H01R 12/71

(52) U.S. Cl. CPC H01R 13/659; H01R 12/71
USPC 439/65; 439/78

(57) ABSTRACT

A cable connector assembly comprises: a first connector module comprising an insulative housing with a plurality of receiving rooms, a plurality of first connectors respectively received into the receiving rooms, a first PCB electrically connected to the plurality of first connectors and a metallic shell enclosing the insulative housing; and a second connector module comprising a second PCB formed therein; a flat wire electrically connecting to the first connector module and the second connector module. One end of the flat wire is electrically connected to the first PCB, and the other end of the flat wire is electrically connected to the second PCB.

### BACKGROUND OF THE INVENTION

1. Field of the Invention

The present invention relates to a cable connector assembly, and more particularly to a cable connector assembly used in a computer case.

2. Description of the Related Art

With the development trend of miniaturization and multifunction of the electric apparatus, the electrical connector formed in the electric apparatus should not only have a good signal transmission, but also have characteristics of miniaturization, simple and easy to use. At present, the interface of USB and Audio Jack have become common I/O ports, and are usually installed on a panel of the computer case to connect the computer with the peripheral equipment.

Generally, the USB and Audio Jack connector are together formed on one side of the cable connector assembly and installed on the panel of the computer case. And the front end of the USB and Audio Jack connectors are located outside of the panel of the computer case. And, a number of electrical connectors are formed on another side of the cable connector assembly and electrically connected to the corresponding board end connectors on the printed circuit board in the computer case. Currently, the existing cable connector assembly usually has several round wires and a plurality of connectors formed at both sides thereof. To avoid several round wires twisted together, a wire management is needed to well arrange the round wires. So the cable connector assembly will have high manufacturing cost due to additional wire management. And, the several round wires will occupy larger room in the computer case. Meanwhile, the cable connector assembly has lower soldering efficiency since several round wires should be welded to the electrical connector by one to one correspondence.

### SUMMARY OF THE INVENTION

Accordingly, an object of the present invention is to provide a cable connector assembly which can realize fast welding process and with a lower manufacturing cost.

In order to achieve the object set forth, a cable connector assembly comprises: a first connector module comprising an insulative housing with a plurality of receiving rooms, a plurality of first connectors respectively received into the receiving rooms, a first PCB electrically connected to the plurality of first connectors and a metallic shell enclosing the insulative housing; and a second connector module comprising a second PCB formed therein; a flat wire electrically connecting to the first connector module and the second connector module. One end of the flat wire is electrically connected to the first PCB, and the other end of the flat wire is electrically connected to the second PCB.

### BRIEF DESCRIPTION OF THE DRAWINGS

FIG. 1 is an assembled, perspective view of a cable connector assembly in accordance with the present invention;

FIG. 2 is an exploded, perspective view of the cable connector assembly as shown in FIG. 1;

FIG. 3 is an another assembled, perspective view of the cable connector assembly as shown in FIG. 1;

FIG. 4 is an another exploded, perspective view of a cable connector assembly as shown in FIG. 2;

FIG. 5 is an another partially assembled view of the cable connector assembly as shown in FIG. 4;

FIG. 6 is a printed circuit board of the cable connector assembly as shown in FIG. 1.

### DESCRIPTION OF PREFERRED EMBODIMENT

Reference will now be made to the drawings to describe the present invention in detail.

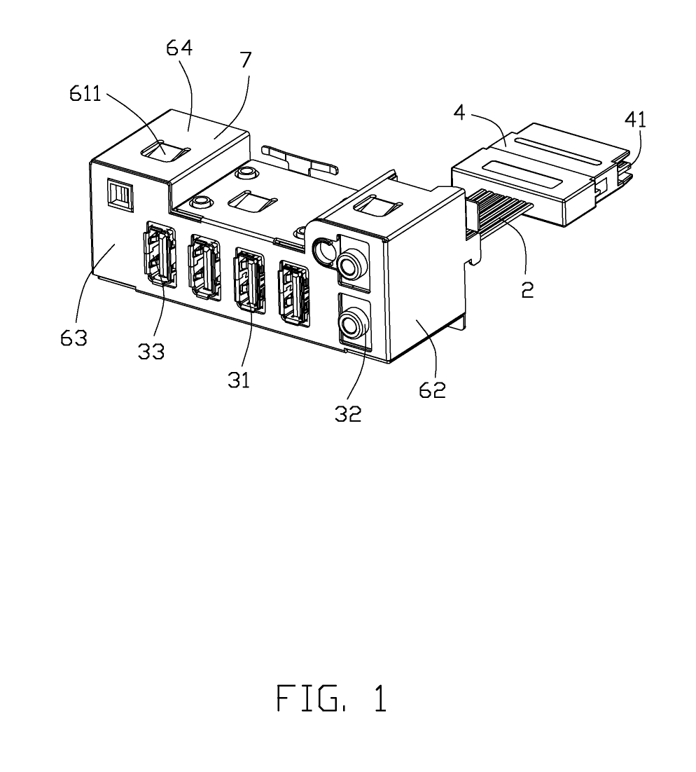

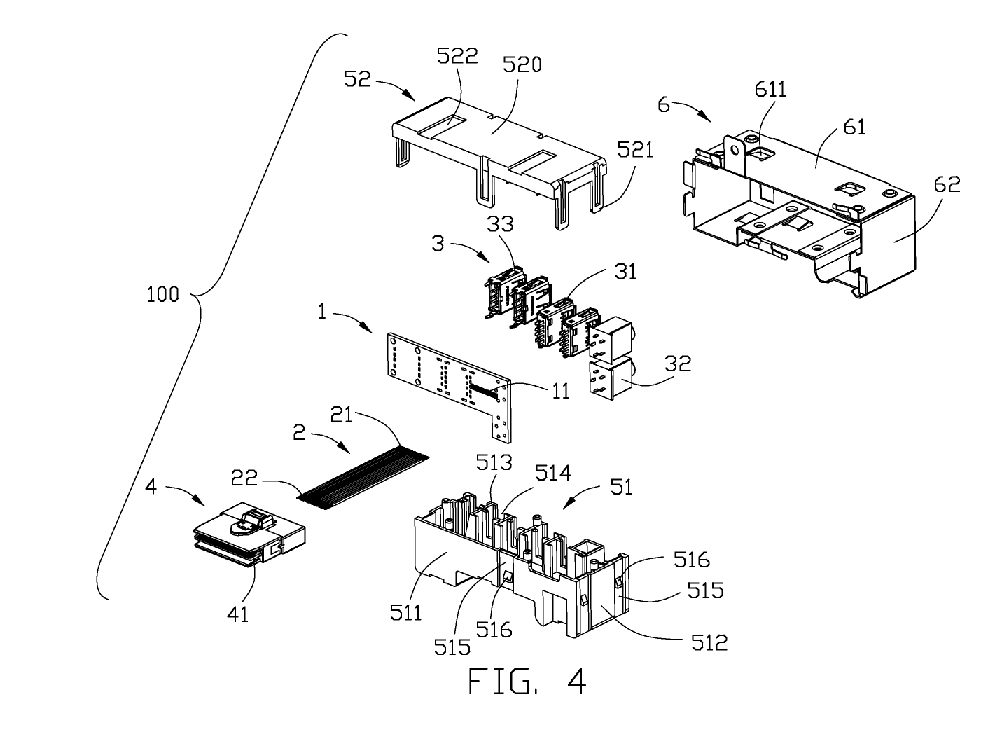

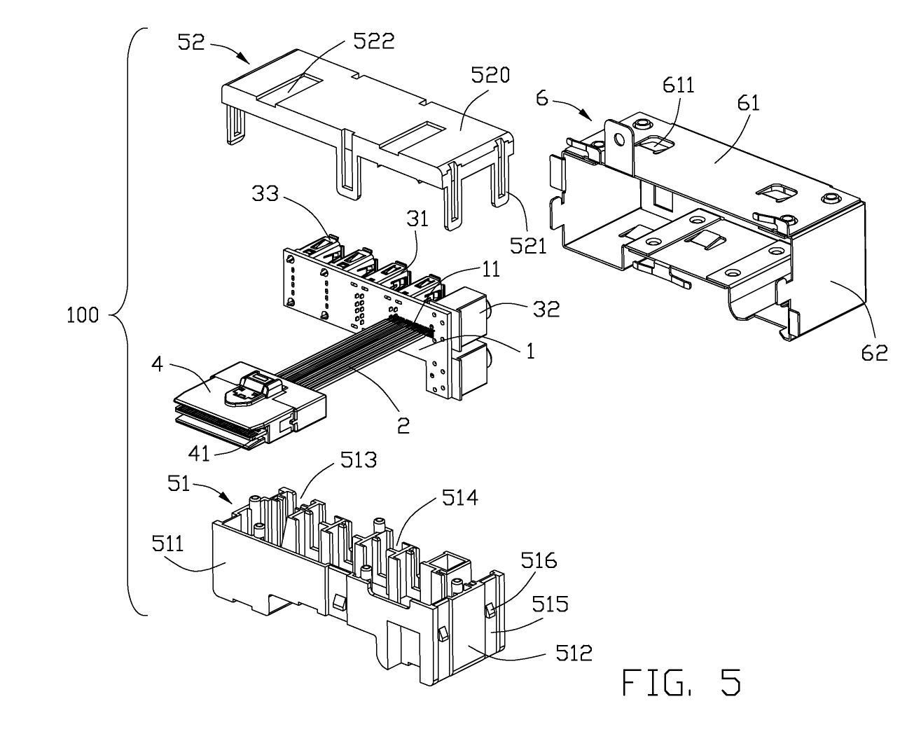

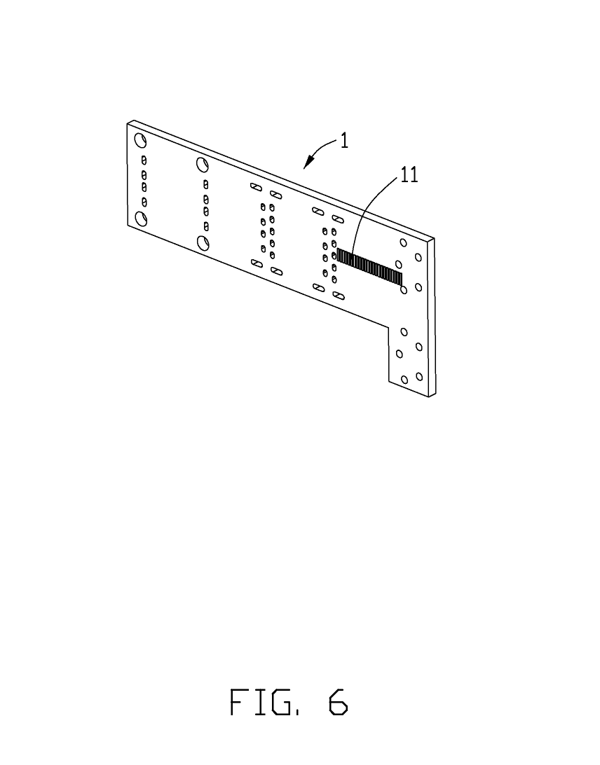

Referring to FIGS. 1 to 6, a cable connector assembly according to the present invention includes a first connector module 7 installed on a panel of a computer case, a second connector module 4 opposite to the first connector module 7 and a flat wire 2 electrically and mechanically connecting the first connector module 7 and the second connector module 4 electrically. Actually, the first connector module 7 is a front I/O module.

Referring to FIGS. 1 to 4, the first connector module 7 includes an insulative housing 5 having a number of receiving rooms arranged along a transversal direction, a plurality of first connectors 3 respectively accommodated into the corresponding receiving rooms, a first PCB 1 electrically connected to the plurality of first connectors 3 electrically and a metallic shell 6 shielding the insulative housing 5.

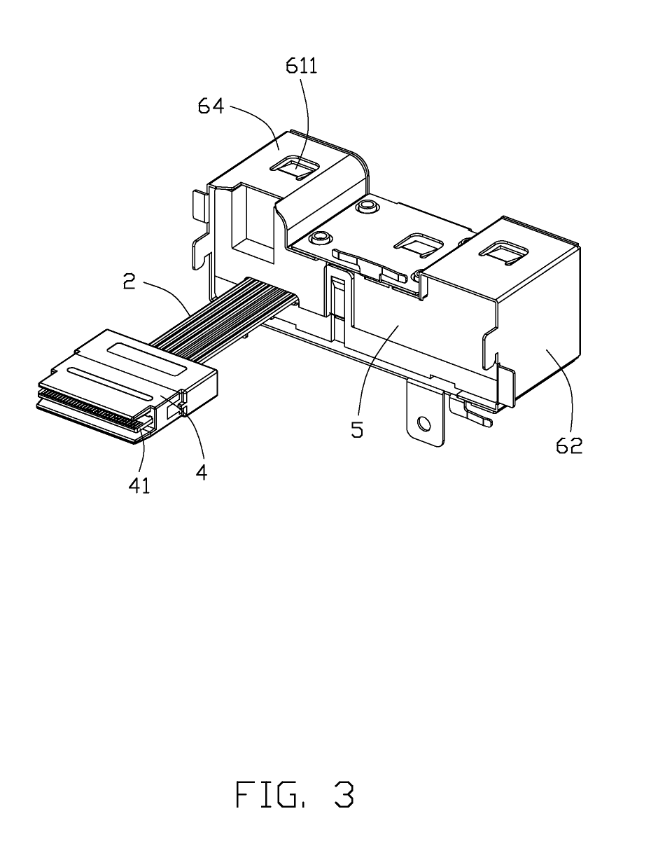

Referring to FIGS. 3 to 5, the insulative housing 5 comprises a first cover 51 and a second cover 52 assembled with the first cover 51. The first cover 51 comprises a rear wall 511, a pair of lateral walls 512 and a top wall 517. There are guiding grooves 515 formed on the rear wall 511 and the lateral wall 512. The first cover 51 defines a plurality of convex blocks 516 respectively formed in the corresponding guiding grooves 515. Each of the convex blocks 516 is located on a bottom surface of the guiding groove 515. There are two retaining grooves 5171 located at two sides of a top surface of the top wall 517 and a first recess recessed downwardly in a middle area of the top surface of the top wall 517. The top wall 517 has a number of partitions 513 extending downwardly. A receiving cavity 514 is formed between every two adjacent partitions 513 to receive a first connector 3. The second cover 52 comprises a bottom wall 520, a peripheral wall extends upward from a top surface of the bottom walls 520. A number of latching member 521 extends upward from the peripheral wall. The latching members 521 are accommodated into the guiding groove 515 of the first cover 51 and latched with the corresponding convex block 516 located in the guiding groove 515. There are two retaining grooves 522 located at two sides of bottom surface of the bottom wall 520 of the second cover 52.

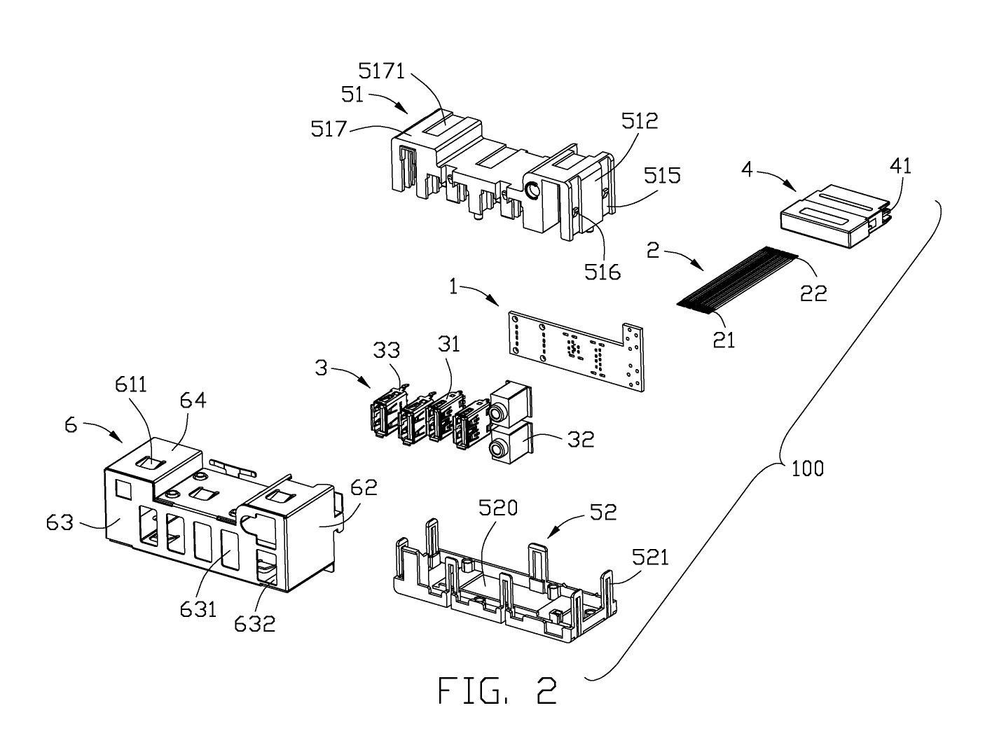

Referring to FIG. 2, the plurality of first connectors 3 includes two USB 2.0 connectors 33, two USB 3.0 connectors 31 and two audio jack connectors 32. The two USB 2.0 connectors 33 and two USB 3.0 connectors 31 are arranged along a transversal direction. The two audio jack connectors 32 are stacked with each other and located on the right side of the two USB 2.0 connectors 33 and two USB 3.0 connectors 31.

Referring to FIGS. 2 to 6, the first PCB 1 is approximately in a L shape. A number of the first connectors 3 are welded to the first PCB 1. The first PCB 1 has a number of conductive pads 11 formed on rear surface thereof and arranged in horizontal direction.

Referring to FIGS. 1 to 5, the metallic shell 6 is structured in a rectangular shape and comprises a bottom wall 61, two lateral walls 62, a front wall 63 and a top wall 64. The bottom wall 61 and the top wall 64 respectively has a number of elastic tabs 611 bent inwardly to engage with the retaining grooves 522, 5171 of the insulative housing 5. The front wall 63 defines four rectangular holes 631 paralleled with each other and arranged along a transversal direction and two holes 632 arranged along a vertical direction to allow the front end of the two USB 2.0 connectors 33, two USB 3.0 connectors 31 and the two audio jack connectors 32 to pass through the metallic shell 6 in a rear-to-front direction. The top wall 64 further defines a second recess formed on a middle area thereof The top wall 64 tightly attaches to the top surface of the insulative housing.

Referring to FIGS. 1 to 5, the second connector module 4 is a Mini SAS connector having a second PCB 41 formed therein. The impedance of the second PCB 41 is 98 ohm. A plurality of rear conductors 22 of the flat wire 2 are welded to the second PCB 41 of the second connector module 4 to realize the electrical connection therebetween.

Referring to FIGS. 2 to 4, the flat wire 2 is located in a flat plane. Two portions of insulative jacket of the flat wire 2 are peeled to make a plurality of front conductors 21 and rear conductors 22 respectively exposed out of the insulative jacket. The plurality of front conductors 21 are welded to the corresponding conductive pads 11 on the rear surface of the first PCB 1. The plurality of rear conductors 22 are welded to the second PCB 41 of the second connector module 4.

Referring to FIGS. 1 to 6, the cable connector assembly 100 according to the present invention can be assembled through following steps. Firstly, the two USB 2.0 connectors 33, the two USB 3.0 connectors 31 and the two audio jack connectors 32 are welded to the first PCB 1 Secondly, the plurality of front conductors 21 of the flat wire 2 are welded to the conductive pads 11 of the first PCB 1 of the first connector module 7 and the plurality of rear conductors 22 of the flat wire 2 are welded to the second PCB 41 of the second connector module 4. Thirdly, the plurality of first connectors 3 and the first PCB 1 are assembled into the first cover 51. The two USB 2.0 connectors 33 and the two USB 3.0 connectors 31 are arranged along the transversal direction and received into the receiving cavity 514 of the first cover 51. The two audio jack connectors 32 are arranged along a vertical direction received into the rest receiving cavities 514 of the first cover 51. Fourthly, the second cover 52 is assembled to the first cover 51. The plurality of latching members 521 of the second cover 52 are received into the corresponding guiding grooves 515 of the first cover 51 and latched to the corresponding convex blocks 516 formed in the guiding groove 515. Then the metallic shell 6 encloses the insulative housing 5 long a front-to-rear direction. The elastic tabs 611 formed on the top wall 64 of the metallic shell 6 are cooperated with the corresponding retaining grooves 5171, 522. At last, the plurality of rear conductors 22 of the flat wire 2 are welded to the second PCB 41 of the second connector module 4.

Through above assembling steps, the cable connector assembly 100 is finished. The cable connector assembly 100 according to the present invention comprises a second first connector module 4 only including a Mini SAS connector mated with a complementary connector (not shown) mounted on a PCB formed in the computer case. Meanwhile, the cable connector assembly 100 comprises a flat wire in stead of traditional round wires to avoid managing round wires. Actually, the cable connector assembly 100 has a lower manufacturing cost and with high assembling efficiency.

What is claimed is:

1. A cable connector assembly comprising:
a first connector module comprising an insulative housing with a plurality of receiving rooms, a plurality of first connectors respectively received into the receiving rooms, a first PCB electrically connected to the plurality of first connectors and a metallic shell enclosing the insulative housing; and
a second connector module comprising a second PCB formed therein;
a flat wire electrically connect to the first connector module and the second connector module; wherein
one end of the flat wire is electrically connected to the first PCB, and the other end of the flat wire is electrically connected to the second PCB.

2. The cable connector assembly as claimed in claim 1, wherein the plurality of first connectors comprise two USB 2.0 connectors, two USB 3.0 connectors arranged along a transversal direction and two audio jack connectors arranged in vertical direction.

3. The cable connector assembly as claimed in claim 1, wherein the first PCB has a plurality of conductive pads formed on a rear surface thereof, the flat wire has a plurality of conductors welded to the corresponding conductive pads.

4. The cable connector assembly as claimed in claim 1, wherein the second connector module is a Mini SAS connector.

5. The cable connector assembly as claimed in claim 4, wherein an impedance of the second PCB in the second connector module is 98 ohm.

6. The cable connector assembly as claimed in claim 1, wherein the insulative housing comprises a first cover and a second cover assembled with the first cover, the first cover has a number of partitions, a plurality of receiving cavities are formed between every two adjacent partitions.

7. The cable connector assembly as claimed in claim 6, wherein the first cover has a plurality of the guiding grooves formed on outer surface, a plurality of convex blocks are respectively formed on a bottom surface of each guiding groove, the second cover defines a plurality of the latching members received into the corresponding guiding grooves and latched with the corresponding convex blocks.

8. The cable connector assembly as claimed in claim 7, wherein a plurality of retaining grooves are formed top wall of the first cover and bottom wall of the second cover, the metallic shell comprises a plurality of elastic tabs respectively received into the corresponding retaining grooves to achieve an engagement between the insulative housing and the metallic shell.

9. The cable connector assembly as claimed in claim 2, wherein the shell has a plurality of holes to allow front ends of the two USB 2.0 connector, two USB 3.0 connector and two audio jack connectors passing through the metallic shell.

10. The cable connector assembly as claimed in claim 1, wherein the insulative housing defines a first recess formed on a top surface thereof, the metallic shell defines a second recess formed on a top wall tightly attached to the top surface.

11. A cable connector assembly comprising:
an insulative housing including a first cover and a second cover assembled to each other along a vertical direction, a plurality of receiving cavities formed in the housing and spaced from each other in a transverse direction perpendicular to said vertical direction, each of said cavities communicating, via a corresponding front opening, with an exterior in a front-to-back direction perpendicular to both said vertical direction and said transverse direction;
a vertically standing printed circuit board;
a plurality of electrical connectors mounted to the printed circuit board in a perpendicular manner and received within the corresponding cavities, respectively, to communicate with the exterior via said openings;
the printed circuit board and the associated connectors being configured to be assembled into the housing only along the vertical direction; and
a flat cable extending through a slot in the housing and having one end mechanically and electrically connected to the printed circuit board and the other end mechanically and electrically connected to an external connector.

12. The cable connector assembly as claimed in claim 11, wherein said end of the flat cable is directly soldered upon the printed circuit board.

13. The cable connector assembly as claimed in 11, wherein each of said connectors has corresponding contact tails arranged in rows along the vertical direction while the flat cable includes a plurality of wires side by side arranged with one another along the transverse direction.

14. The cable connector assembly as claimed in claim 11, further including a metallic shell enclosing the housing except a rear face of the housing where the slot is formed.

15. The cable connector assembly as claimed in claim 14, wherein said shell and said housing are configured to allow said shell to be rearwardly assembled to the housing only along the front-to-back direction.

16. The cable connector assembly as claimed in claim 11, wherein the other end of the flat cable is soldered to another printed circuit board in said external connector.

17. A cable connector assembly comprising:
a first printed circuit board extending along a plane defined by a vertical direction and a transverse direction perpendicular to each other;
a plurality of electrical connectors extending upon a front face of the printed circuit board in a perpendicular manner to have corresponding mating ports exposed forwardly toward an exterior in a front-to-back direction perpendicular to both said vertical direction and said transverse direction;
an insulative housing defining a plurality of cavities essentially extending along both said vertical direction and said front-to-back direction to communicate with the exterior via corresponding front openings in a front face of the housing, wherein said connectors are disposed in the corresponding cavities, respectively; and
a flat cable mechanically and electrically connected to a back face of the printed circuit board.

18. The cable connector assembly as claimed in claim 17, wherein said flat cable includes a plurality of wires arranged with one another along the transverse direction.

19. The cable connector assembly as claimed in claim 18, wherein each of said connectors has corresponding contact tails soldered to the printed circuit board in at least one row along said vertical direction.

20. The cable connector assembly as claimed in claim 19, further including a metallic shell enclosing said housing except a rear face of the housing, wherein the shell is configured to be assembled unto the housing along only the front-to-back direction.
